(19) United States
(12) Patent Application Publication
(10) Pub. No.: US 2004/0187164 A1
(43) Pub. Date: Sep. 23, 2004

(54) Method of and apparatus for selecting television programs for recording and remotely transmitting control information to a recording device to record the selected television programs

(75) Inventors: David R. Kandasamy, Palo Alto, CA (US); Wendy F. Kandasamy, Palo Alto, CA (US); Gaudencio C. Ramil, Fremont, CA (US); Joel A. Parker, San Jose, CA (US); Eduardo F. Llach, Palo Alto, CA (US)

Correspondence Address: HAVERSTOCK & OWENS LLP, 162 NORTH WOLFE ROAD, SUNNYVALE, CA, 94086, US

(73) Assignee: Logic City, Inc.

(21) Appl. No.: 10/769,515

(22) Filed: Jan. 30, 2004

Related U.S. Application Data
(60) Provisional application No. 60/446,861, filed on Feb. 11, 2003.

(51) Int. Cl. H04N 7/173; H04N 7/16; H04N 5/445; G06F 13/00

(52) U.S. Cl. 725/132; 725/140; 725/58

(57) ABSTRACT

A system for and method of remotely controlling a recording device is disclosed. In one embodiment, the system comprises a program server coupled to a signal transmitter. The program server is configured to (1) allow searching a pool of programs from which one or more programs are selected for recording, (2) translate information related to the selected programs into one or more control codes used to control a recording device for recording the selected programs, and (3) transmit the control codes to the signal transmitter. The signal transmitter is configured to receive the control codes and store them. The signal transmitter is further configured to emit control signals containing the control codes and used to control the recording device to record the selected programs, either manually or by programming the recording the device to record the programs at a later date and time.

### RELATED APPLICATION

This application claims priority under 35 U.S.C. §119(e) of the co-pending U.S. Provisional Application Serial No. 60/446,861, filed on Feb. 11, 2003, and titled “METHOD OF AND APPARATUS FOR SELECTING TELEVISION PROGRAMS FOR RECORDING AND REMOTELY TRANSMITTING CONTROL INFORMATION TO A RECORDING DEVICE TO RECORD THE SELECTED TELEVISION PROGRAMS.” The Provisional Application Serial No. 60/446,861, filed on Feb. 11, 2003, and titled “METHOD OF AND APPARATUS FOR SELECTING TELEVISION PROGRAMS FOR RECORDING AND REMOTELY TRANSMITTING CONTROL INFORMATION TO A RECORDING DEVICE TO RECORD THE SELECTED TELEVISION PROGRAMS” is hereby incorporated by reference.

### FIELD OF THE INVENTION

This invention relates to device controllers. More specifically, this invention relates to a system for and a method of programmably controlling or remotely controlling the recording of video and audio programs.

### BACKGROUND OF THE INVENTION

A video or other recorder can be controlled, either directly, by pressing a series of keys on its control panel, or remotely, by aiming a remote control unit directly at a detector on its control panel. Thus, when remotely controlling a video recorder, a user must be near the video recorder and within its line of sight. Moreover, the user must know either a programming code published in program listings or the start time, stop time, and channel on which the video program is broadcast. Remote control units thus do not work when a user is far from the video recorder; nor do they work correctly unless a user knows sufficient programming information with which to program the video recorder.

### SUMMARY OF THE INVENTION

A system that allows users to select television programs for recording and for remotely controlling a recording device to record the selected television programs extends the capabilities of many recording devices. Using embodiments of the present invention, a user at a distant host (e.g., at work or a vacation site) can remotely control a recording device to record selected programs. The user can also log onto a Program Server equipped with program selection tools that allow a user to easily select programs to be recorded.

In a first aspect of the present invention, a system comprises a programmable first unit and a signal transmitter coupled to the first unit. The programmable first unit is configured to translate programming information into one or more remote control codes. The signal transmitter is configured to translate the remote control codes into control signals for controlling a recording device and to transmit the control signals to the recording device. The first unit comprises a program server coupled to the signal transmitter. Preferably, the program server is configured to generate the programming information and to translate the programming information into the remote control codes.

In one embodiment, the system further comprises a remote host coupled to the program server and to the signal transmitter. The program server is configured to generate the programming information and the remote host is configured to receive the programming information and to translate the programming information into the remote control codes. Preferably, the program server is coupled to the remote host over a wide area network, such as the Internet. Alternatively, the program server is coupled to the remote host over a local area network.

In one embodiment, the programming information corresponds to an occurrence of a program. The program is a broadcast video program or a broadcast audio program.

Preferably, the signal transmitter is programmed to automatically transmit the control signals to the recording device at programmed times. Alternatively or additionally, the remote control codes are configured to program the recording device to automatically record a program at a programmed time. In one embodiment, the signal transmitter comprises a personal digital assistant. Alternatively, the signal transmitter comprises a cellular phone.

The system further comprises a recording device configured to receive the remote control signals. The recording device comprises a video cassette recorder, a digital video recorder, or an audio recorder. The audio recorder comprises a wireless receiver, an audio tuner coupled to the wireless receiver, and a programmable digital recorder coupled to the audio tuner. The programmable digital recorder is configured to receive remote control codes over the wireless receiver from a program server at programmed times.

Preferably, the program server is configured to select one or more programs from a pool of programs, thereby generating a list of programming information. The program server is configured to select the one or more programs using a selection criterion. The selection criterion is that a segment of a program title matches a target string or that a season number of a program matches a predetermined season number.

Preferably, the signal transmitter comprises an infra red transmitter. Alternatively, the signal transmitter comprises a radio frequency transmitter or a serial bus. In one embodiment, the system further comprises a radio frequency extender coupling the remote host to the recording device. In another embodiment, the remote host and the signal transmitter are a single machine.

In a second aspect of the present invention, a system comprises means for programmably generating one or more remote control codes used to record a program on a recording device, and means for translating the remote control codes into control signals for controlling the recording device. The means for transmitting is further configured to transmit the control signals to the recording device.

In a third aspect of the present invention, a method of recording a program comprises sending one or more remote control codes to a first device; receiving the remote control codes on the first device, translating the remote control codes into control signals to control a recording device to record a program; and transmitting the control signals from the first device to the recording device. The method further comprises translating programming information related to the occurrence of a program into a sequence of the one or more remote control codes. The sequence of one or more remote control codes corresponds to a key sequence for recording a program. The program is a broadcast video program or a broadcast audio program.

Preferably, the remote control codes are sent to the first device at programmed times. Alternatively or additionally, the remote control codes relate to programming the recording device to record a program at a programmed time. The recording device comprises a video cassette recorder, a digital video recorder, or an audio recorder.

Preferably, the method further comprises presenting a pool of programs from which one or more programs can be selected for recording. The method further comprises selecting one or more programs from the pool of programs and translating programming information related to the one or more occurrences of the one or more programs into the remote control codes. In one embodiment, selecting a program is performed on a second device coupled to the first device. Preferably, the first device is coupled to the second device over a wide area network comprising the Internet. Alternatively, the first device and the second device are coupled over a local area network. In one embodiment, selecting the programs and translating the programming information are performed on a single machine.

Preferably, the selected programs are selected according to a selection criterion such as a segment of a program title matches a target string or a season number of a program matches a predetermined season number.

In a fourth aspect of the present invention, a method of recording a program comprises wirelessly receiving programming information corresponding to the broadcast of the program, tuning a receiver according to the programming information to receive the program, and storing the program. Preferably, the method further comprises selecting one or more programs from a pool of programs, thereby generating a list of programming information, and wirelessly transmitting the list to the receiver. The one or more programs are selected from a pool of programs using a selection criterion such as a segment of a program title matches a target string or a season number of a program matches a predetermined season number. The program is a broadcast video program or a broadcast audio program.

In a fifth aspect of the present invention, a network of devices comprises a program server, a signal transmitter coupled to the program server, and a recording device coupled to the signal transmitter. The program server is configured to select one or more programs from a pool of programs, thereby generating a list of programming information. The program server is further configured to translate the list of programming information into remote control codes. The signal transmitter is configured to receive the remote control codes from the program server. The signal transmitter is also configured to translate the remote control codes into control signals and to transmit the control signals to the recording device. The recording device is configured to receive the control signals for recording a program. The programming information corresponds to the occurrence of a broadcast program such as a broadcast video program or a broadcast audio program.

Preferably, the signal transmitter is programmed to automatically transmit the remote control codes to the recording device at programmed times. Alternatively or additionally, the remote control codes program the recording device to record the program at a programmed time. The recording device comprises a video cassette recorder, a digital video recorder, or an audio recorder.

Preferably, the program server is coupled to the signal transmitter over a wide area network comprising the Internet. Alternatively, the program server is coupled to the signal transmitter over a local area network. Preferably, the program server is configured to select one or more programs from the pool of programs using a selection criteria. Preferably, the signal transmitter comprises an infra red transmitter electronically coupling the signal transmitter and the recording device. Alternatively, the signal transmitter comprises a radio frequency transmitter or a serial bus electronically coupling the signal transmitter and the recording device.

In a sixth aspect of the present invention, a system comprises a program signal source for receiving a program signal, a first device coupled to the program signal source, the first device for transmitting the program signal, a second device configured to receive and store the transmitted program signal, and a signal transmitter configured to transmit remote control codes to the program signal source, thereby controlling the transmission of program signals from the first device to the second device.

In one embodiment, the program signal source is one of a cable box or a satellite box. The second device comprises a digital video recorder or a video cassette recorder. Preferably, the first device is configured to transmit the program signal using radio frequency waves and the signal transmitter is configured to transmit the remote control codes using radio frequency waves.

In one embodiment, the system further comprises a program server coupled to the second device. The program server is configured to transmit the remote control codes to the second device. The remote control codes are related to the recording of a program. The program is a broadcast video program or a broadcast audio program.

Preferably, the program server is coupled to the second device over a wide area network comprising the Internet. Alternatively, the program server is coupled to the second device over a local area network.

### BRIEF DESCRIPTION OF THE SEVERAL VIEWS OF THE DRAWINGS

FIG. 1 shows a computer system coupled to an infra red transmitter that transmits control codes to a video cassette recorder (VCR), thus controlling the VCR, in accordance with the present invention.

FIG. 2A shows a personal digital assistant coupled to the computer system of FIG. 1 and programmed for remotely controlling the VCR of FIG. 1 in accordance with the present invention.

FIG. 2B shows the programmed personal digital assistant of FIG. 2A, remotely controlling the VCR in accordance with the present invention.

FIG. 3 shows a personal digital assistant coupled to a cellular telephone and using an infra red transmitter of the cellular phone to remotely control a VCR in accordance with the present invention.

FIG. 4 is a block diagram of a PC card in the computer system of FIG. 1, coupled to an oscillator and LED of a Signal Transmitter in accordance with the present invention.

FIG. 5 shows a customer system coupled to a Program Server, the Program Server coupled to a remote host and Signal Transmitter, the Signal Transmitter configured to transmit control codes to the VCR, thereby controlling the VCR in accordance with the present invention.

FIG. 6 shows a system similar to that of FIG. 5, with the Signal Transmitter having a serial timer module.

FIG. 7 shows a system similar to that in FIG. 5 but without the remote host, instead using an intelligent Signal Transmitter containing an Ethernet Timer module.

FIG. 8 shows a system similar to that in FIG. 7 with the intelligent Signal Transmitter having a modem and a timer module.

FIG. 9 shows a system for receiving control codes on a digital cable tuner or a satellite receiver in accordance with the present invention.

FIG. 10 shows two entries in a Record Table or List, in accordance with the present invention.

FIG. 11 shows a device template used to record programs on a particular recording device in accordance with the present invention.

FIG. 12 is a screen shot of an ordered listing of programs for selection for recording in accordance with the present invention.

FIG. 13 is a screen shot of an interface to a movie database search engine for searching and selecting programs for recording in accordance with the present invention.

FIG. 14 is a flow chart for the steps taken in a Program Server in accordance with the present invention.

FIG. 15 is a flow chart for a parent process that spawns a child process used to control the recording of a program in accordance with the present invention.

FIG. 16 is a flow chart for the child process of FIG. 15, in accordance with the present invention.

FIG. 17 is a flow chart for adding an entry to a Record List in accordance with the present invention.

FIG. 18 is a flow chart for a parent process that spawns one or more child processes each used to control the recording of a program in accordance with the present invention.

FIG. 19 is a flow chart for a child process of FIG. 18, in accordance with the present invention.

FIG. 20 is a schematic of an RF extender coupling a Signal Transmitter to a VCR in accordance with the present invention.

FIG. 21 is a schematic of a video source coupled to a video sender and a personal computer coupled to a Signal Transmitter in accordance with the present invention.

### DETAILED DESCRIPTION OF THE INVENTION

Embodiments of the present invention allow for remotely controlling a recording device, such as a video cassette recorder (VCR), a digital video recorder (DVR), a digital audio recorder, disk-drive based recorders (e.g., Tivo™ and Replay™), personal video recorders (PVRs) that use PCs, or any other recording device that can be controlled. Thus, for example, a user on a host computer (a “customer host”) remote from the recording device has the ability to remotely control the recording device. Thus, a user at work can control a recording device at home, without leaving her office, merely by accessing a signal transmitter over the Internet, over a local area network, or by other means. The signal transmitter is used to transmit remote control codes (also referred to herein as “control codes”) to the recording device. The customer host is also configured to access a program server containing a graphical user interface (GUT) and program search tools that allow the user to easily select programs for later recording. The program server also stores user preferences so that the user is alerted about programs that she may find interesting. Alternatively, the program server automatically selects programs that are recorded by the recording device, without additional user intervention.

As described in more detail below, a system in accordance with the present invention can have many configurations. For example, in one embodiment a system comprises a first unit coupled to a signal transmitter. The first unit contains a GUI and program search tools, used to (1) select a list of programs to record (generate a Record List) and (2) translate the Record List into a sequence of control codes that are transmitted to the signal transmitter. The signal transmitter encodes the control codes onto control signals that, when transmitted to a recording device, controls the recording device to record the programs. Preferably, the control codes are transmitted from the first unit to the signal transmitter at a time approximate to the start and stop times of the program. Alternatively, or additionally, the control codes are transmitted from the first unit to the recording device to program the recording device to record the program at a pre-determined time. The control are signals similar or identical to those emitted by a remote control unit when one or more keys are pressed. Thus, in one embodiment, the control codes correspond to keys on the recording device's remote control unit.

In one embodiment, the first unit comprises a program server that performs both the tasks of generating the Record List, generating corresponding programming information, and translating the programming information into remote control codes. In another embodiment, the first unit comprises a program server coupled to a remote host. The program server is used to generate the Record List, generating corresponding programming information, and transmitting the list to the remote host. The remote host translates the programming information into the remote control codes, which are then transmitted to the signal transmitter. It will be appreciated that the tasks of generating the Record List, generating corresponding programming information, and translating the programming information can be divided among the program server, the remote host, and other components in other ways in accordance with embodiments of the present invention. For example, the signal transmitter can contain a processor and can thus perform the task of translating the Record List into control codes. In this embodiment, the remote host would be unnecessary. Alternatively, as described below, the tasks of the Program Server and the remote host are performed on a single computer system.

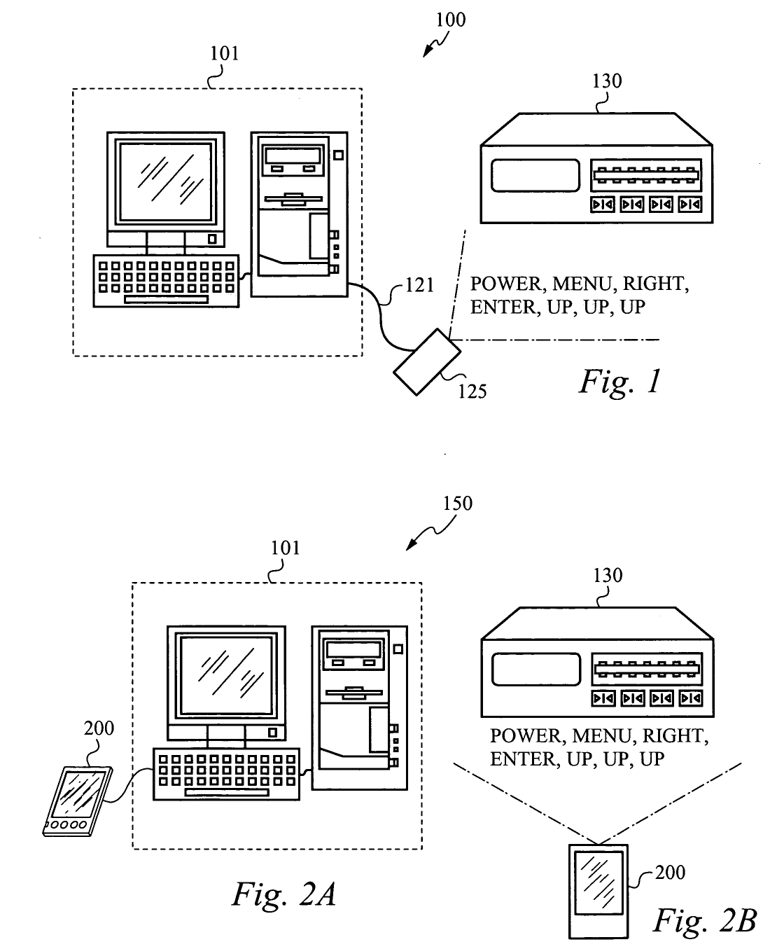

FIG. 1 shows a system 100 in accordance with one embodiment of the present invention. The system 100 comprises a remote host 101 coupled to a signal transmitter 125 by a cable 121. In one embodiment, the remote host 101 is equipped with a USB card and is connected to the signal transmitter 125 by a USB cable 121. Alternatively, the remote host 101 is equipped with an RS-232 port, and is connected to the signal transmitter 125 by an RS-232 cable 121. It will be appreciated that alternatively the remote host 101 is coupled to the signal transmitter 125 using any other appropriate means, such as a wireless connection.

The signal transmitter 125 is coupled to a video cassette recorder (VCR) 130, preferably using electromagnetic radiation. Preferably, the signal transmitter 125 is an infra red (IR) transmitter, and the VCR 130 is configured to receive control signals, control codes encoded on an IR carrier signal. It will be appreciated, however, that alternatively the signal transmitter 125 transmits control codes using any other appropriate type of carrier signal, such as other forms of electromagnetic energy including, but not limited to, visible light and radio waves. The signal transmitter 125 can also transmit signals to the VCR 130 using radio frequency (RF) signals or over a serial cable coupled to serial ports on both the signal transmitter 125 and the VCR 130. While FIG. 1 shows the system 100 having a VCR 130, it will be appreciated that other types of recorders can be controlled using the present invention including, but not limited to, video digital recorders, audio recorders, disk-drive based recorders, and PVRs.

In a preferred embodiment, the signal transmitter 125 is configured to remotely control the VCR 130 using control signals containing control codes. Preferably, the control codes correspond to keys on a remote control unit that transmits signals recognized by the VCR 130. For example, to turn the VCR 130 on, the signal transmitter 125 emits a control signal corresponding to the POWER ON button on the remote control unit (not shown) of the VCR 130. Embodiments of the present invention thus make use of the built-in features of recording devices that allow them to be remotely controlled, such as by a remote control unit. Using these features, any number of recording devices can be controlled merely by using the same control signals used by the devices' corresponding remote control unit. The recording device does not have to be altered in any way.

It will be appreciated by those skilled in the art that the control codes can be encoded onto the carrier signal by modulating the carrier signal with the control codes using a variety of modulation schemes including those schemes used with the control codes RC5, RC6, REC-80, and their variants. It will be appreciated by those skilled in the art that control codes can be combined with other information to form a control packet that is encoded onto the carrier signal. The control packet can thus contain initiation and start bits, toggle bits that indicate whether a button is being held down or has been successively pressed multiple times, address bits that identify the device being controlled, redundant bits for error checking, all in addition to the control code indicating the key pressed.

In the explanation of FIG. 1, a user (also referred to as a customer) enters programming information into a program executing on the remote host 101, the “Control Program.” The programming information indicates a program he wishes recorded. Later examples show how a user can select this information from a Program Server coupled to the remote host 101. For example, the user enters the record “35243 Tue+1/14 8-9pm KCBS-5 Survivor” (corresponding to the “Selected Show”) into a field in a GUI; the Control Program then copies the record into a Record List or other data structure. This record thus contains programming information that uniquely identifies a program and allows it to be recorded. It will be appreciated that programming information can contain other information and combinations of information that are used to identify a program to be recorded. The first field of the record contains a program listing code, “35243,” which contains a code contained in television listings to uniquely identify a broadcast program; the second field contains the day that the program is broadcast-here, “Tue+” indicates that the program is shown every Tuesday; the third field, containing “1/14,” gives the starting date as January 14; the fourth field, containing “8-9pm,” indicates that the program is broadcast from 8:00 p.m. to 9:00 p.m.; the fifth field, containing “KCBS-5,” indicates that the program is broadcast on channel 5; and the sixth field, containing “Survivor,” indicates the name of the program. It will be appreciated that if a field is unnecessary, it can contain a wildcard character, another character, or no character at all.

The Control Program is preferably written in a scripting language, such as PERL, UNIX shell, or any other command scripting language. Alternatively, the Control Program is written in a compiled language, such as the C programming language. The Control Program (a) parses the record, (b) translates each record into a series of KEY sequences, each KEY corresponding to a KEY on the remote control unit, (c) translates each KEY into a corresponding control code, and (d) sequentially transmits each control code to the signal transmitter 125. The signal transmitter 125 then transmits the corresponding control signals to the VCR 130. The Control Program generates control codes and controls the transmission of the control codes to the signal transmitter 125 in several ways.

A first embodiment is now described, using the letters (a) through (d) to correspond to the steps discussed in the previous paragraph. In the first embodiment of the present invention, the Control Program (a) parses the record to read the program listing code, “35243.” The Control Program then (b) translates the program listing code into a sequence of remote control keys that will program the recording device to record the program at the scheduled time on the scheduled channel. For example, for one manufacturer's device, a recording device can be programmed to record a program that has the program listing code 35243 by pressing the following keys on the device's remote control unit: PROGRAM LISTING 35243 ENTER. Thus the Control Program will translate the record into this KEY sequence. Next, the Control Program (c) translates each KEY sequence into its corresponding control code. Thus, for example, if the keys PROGRAM LISTING 35243 ENTER have the corresponding control codes 10000000 10000001 10000010 10000011, then the record will be translated into the bit sequence (control codes) 10000000 10000001 10000010 10000011. Next, the Control Program (d) transmits the bit sequence 10000000 10000001 10000010 10000011 to the signal transmitter 125, which emits them to the VCR 130, preferably in blocks the size of each control code. It will be appreciated that either the Control Program or the signal transmitter can insert delays between each control code to ensure that the VCR received and processed the previous control code.

In a second embodiment, described in more detail below, after parsing the record, the Control Program uses the starting date and time and the ending date and time (the third and fourth fields in the record), and the channel (the fifth field) to program the VCR 130. Thus, for example, the Control Program (a) parses the record to read the channel, starting date and time, and ending date and time. The Control Program then (b) translates the programming information (the start date, etc.) into a KEY sequence to program a recording device to record the Selected Show. For example, for one manufacturer's device, pressing the following sequence of keys (capitalized letters refer to the keys pressed) can be pressed on the device's remote control unit; comments within parentheses do not reflect keys pressed but are for explanation only: PROGRAM (enter program mode, menu) KEY-UP (get to correct menu item) 0114 (start month and day) ENTER 0800 PM (start time) ENTER 0900 PM (stop time) ENTER 05 (channel) ENTER PROGRAM (end). The Control Program will thus translate the record into this KEY sequence. Next, the Control Program (c) translates each KEY sequence into its corresponding control code in a manner similar to that discussed above. Next, the Control Program (d) transmits the bit sequence (i.e., the sequence of control codes) 10000000 10000001 10000010 10000011 to the signal transmitter 125, which emits the corresponding control signals to the VCR 130.

In a third embodiment, described in more detail below, after parsing the record, the Control Program sends control signals to the recording device at or near the time the start of the Selected Show. For example, the Control Program will send control signals to power on the VCR, select the channel the Selected Show is broadcast on, and begin recording. At the stop time stored in the record, the Control Program will send a control signal to the VCR corresponding to the STOP key. The Control Program can also initialize the VCR is many ways. For example, the Control Program can set the VCR's channel to a known channel to reduce the number of KEYS required in a KEY sequence.

It will be appreciated that alternatively the sequence of control codes is generated in other ways. For example as shown in FIG. 11, the sequence of control codes is stored in a device template or macro that, when filled in with parameters from the record, forms either the sequence of KEYS (which is later translated to the control codes), or directly expands to the control codes.

It will be appreciated that the Control Program can be used to transmit control signals to the VCR 130 to perform a variety of tasks, such as setting a clock on the VCR 130, resetting timers, cancelling a programmed recording, or any other VCR functions that can be controlled remotely. The sequence of keys generated by a Control Program will correspond to the task requested.

The control codes used to control a recording device can be discovered in a variety of ways. For example, they may be published by a manufacturer of a recording device. They can be observed by configuring a device that receives the signals from the recording device's remote control unit and displays the control codes. The device can comprise, for example, a photo diode to receive the control signal and a processor to extract the control codes. Control codes can be observed and noted for each key pressed.

It will be appreciated that using a remote host to control a recording device has many advantages. For example, a recording device may be programmed using its internal memory. However, this capability can be limited. For example, a recording device may be capable of recording only 8 programs. Using the third embodiment described above, the recording device can record any number of programs, limited only by the larger processing power and memory of the remote host.

A recording device in accordance with the present invention is remotely controlled using many configurations. Devices other than a signal transmitter 130 can be used to control (e.g., program) a recording device. For example, as shown in FIG. 2A, a recording system 150 comprises a personal digital assistant (PDA) 200 coupled to the remote host 101 and configured to receive a Record List from the remote host 101. The PDA 200 comprises (a) a memory for storing the Record List, (b) a processor and associated programs to translate the Record List into a sequence of KEYS and to translate the KEYS into corresponding control codes, and (c) an infra red signal emitter.

After the Record List has been stored onto the memory of the PDA 200 (FIG. 2A), the PDA 200 is placed within a line of sight of the VCR 130, as shown in FIG. 2B. The PDA 200 is then used to emit control signals to control the VCR 130, such as by programming the VCR 130 to record one or more programs at a later date or time.

The system of FIG. 2A is thus useful when a user has access to a Program Server, described in more detail below, at work but not where the recording device is, such as home. While at work, the user can thus easily download the programming information for selected programs onto the PDA 200 and, when he arrives home, download the programming information to the remote host 101. The remote host 101 will now be configured to record selected programs.

In a preferred embodiment when using a PDA, the Record List rather than the KEY sequences is loaded onto the PDA 200. This is preferable because the current time may be needed to generate the actual keystrokes, which can only be done when the user is holding the PDA 200 in front of the VCR 130. If the current time is not needed, it will be appreciated that the KEY sequences can be generated on the remote host 101 and transferred to the PDA 200, which can then translate them into control codes.

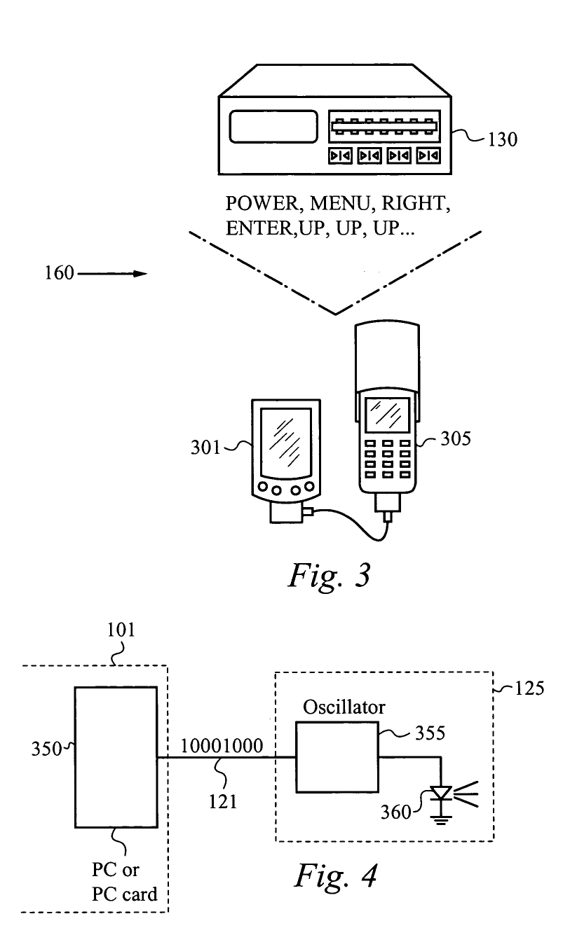

In another embodiment of the present invention, shown in FIG. 3, a recording system 160 comprises a PDA 301 coupled to a cell phone 305 and configured to receive a Record List or other programming information from a remote host. In one embodiment, the cell phone 305 receives the record List wirelessly from a remote host (not shown). The cell phone 305 transfers the Record List to the PDA 305, which translates the Record List into control signals. The PDA 305 uses its infra red emitter to transmit the control signals to the recording device 130.

It will be appreciated that alternatively the system 160 uses devices other than the cell phone 301 to couple the PDA 305 to a remote host over the Internet. As an example, the system 160 uses a modem to couple the PDA 305 to the remote host.

In another embodiment of the invention, a PDA is used as a timer. Thus, at a start time for a program to be recorded, the PDA sends to the VCR 130 the sequence of control signals corresponding to the control codes POWER ON and RECORD. At the end of the program, the PDA sends to the recording device 130 the control codes corresponding to the sequence of keys STOP and POWER OFF.

In some embodiments, when setting recording times, the current time is required to determine the number of UP and DOWN key presses (used, for example, to set the recording time) that must be transmitted to program the recording device. Thus, the clock in the computer system 101 (FIG. 1) or the PDA 301 (FIG. 3) needs to be somewhat synchronized with the VCR 130. Preferably, an error range of approximately 3 minutes is tolerable. Greater errors could result in the beginning or the ending of a TV program being clipped out. In one embodiment, the user inputs the recording device time into the remote host 101 or the PDA 301 at the beginning of the programming sequence. Later control signals can then update the clock on the VCR 130 if necessary.

It will be appreciated that clock synchronization differences can cause another large error. For example, referring again to FIG. 1, if a clock on the VCR 130 is set to 10:43 p.m. and the clock on the remote host 101 is set to 10:45 p.m., then the skew would be acceptable. If the VCR 130 is programmed to start recording at 9:00 p.m., the start time can be set by transmitting control signals corresponding to 15 UP keys, where UP and DOWN keys are used to increment or decrement a timer value such as the hour setting. However, on the VCR 130, 43 (current minute setting)+15 (UP keys used to set the start minute setting) would yield 58 rather than 00. Thus, the timer would be set to start recording at 9:58 p.m., considerably different from the desired 9:00 p.m. start time. In accordance with one embodiment, the VCR clock is set permanently 5 minutes fast. That is, if the current time is 10:45 p.m., the VCR's clock is set to 10:50 p.m. Correspondingly, all start and end times are set 5 minutes later on the VCR's timer. Thus, the desired 9:00 p.m. start time would be set on the VCR 130 as 9:05 p.m. start time. As long as the clock skew between the VCR 130 and the remote host 101 remains within 6 minutes, the wrap around problem is avoided. It will be appreciated that the remote host 101 and VCR 130 can be synchronized in other ways using, for example, other tolerances.

FIG. 4 shows the coupling between the remote host 101 and the signal transmitter 125, both of FIG. 1, in more detail. The signal transmitter 125 comprises an oscillator 355 coupled to an infra red emitter 360. As shown in FIG. 1, the remote host 101 transmits a control packet containing control codes to the port on which it is coupled to the signal transmitter 125. Again referring to FIG. 4, the signal transmitter 125 receives this control packet which is transmitted to the input of the oscillator 355, which generates a carrier signal. The control packet (e.g., the control codes and other information such as device address) modulates the carrier signal to generate a control signal that is emitted by the infra red transmitter 360 and transmitted to the VCR 130.

Preferably, the oscillator 355 operates within a frequency range of between 10 kHz and 100 kHz. Many commercial remote control units and their corresponding remote controlled devices operate at between approximately 36 k Hz and 40 k Hz. It will be appreciated that the signal transmitter 125 can comprise multiple oscillators, each tuned to a manufacturer's family of devices. For example, a user may wish to control a Toshiba VCR, an RCA VCR, and an RCA DVR. Those skilled in the art will appreciate that the Toshiba VCR can be controlled, for example, by control signals on a 38 k Hz carrier frequency. The RCA VCR can be controlled by, for example, control signals on a 40 k Hz carrier frequency and addressed to (having a value in the address field of a control packet) “Device 1.” The RCA DVR can be controlled by, for example, control signals on a 40 k Hz carrier frequency and addressed to (having a value in the address field of a control packet) “Device 2.” Thus, a signal transmitter can have various oscillators each generating a carrier signal for controlling one family of devices. The remote host 101 can then be used to generate a control packet containing control codes as well as device addresses for controlling particular devices in a device family. Some of these values can be default values relating to a remote host, such as when a remote host is configured to control only one recording unit that operates at one tape speed.

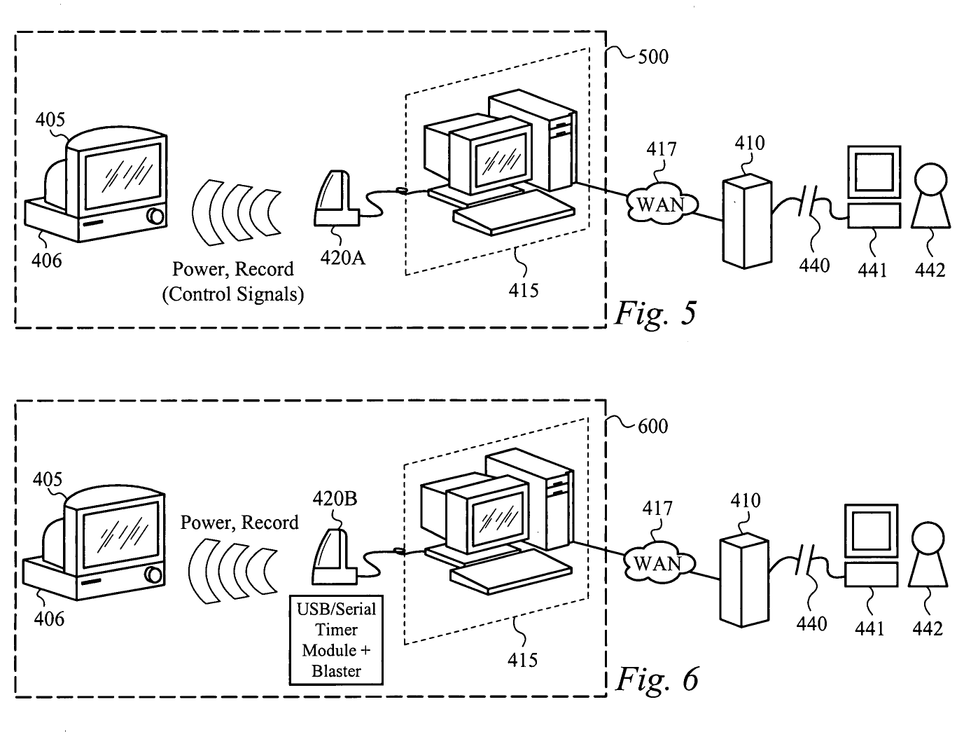

FIG. 5 shows a system 500 in accordance with the present invention. The system 500 is coupled over a WAN 417 to a Program Server 410, described in more detail below. The Program Server 410 is accessed by a customer 442 on a customer host 441, which is coupled to the Program Server 410 over a connection 440. The system 500 comprises a recording device 406 coupled to a television set 405. The recording device 406 is coupled to a transmission system such as a cable network or satellite system used for receiving broadcast programs. The system 500 also comprises a remote host 415 coupled to a signal transmitter 420A that, in operation, is placed in a line of sight of a IR remote control receiver of the recording device 406. The remote host 415 is coupled to the WAN 417.

As described in more detail below, in operation, the customer 442 logs onto the customer host 441 to access the Program Server 410 over the connection 440. The connection 440 can comprise a local area network, a serial connection such as one using an RS-232 connector, a wide area network such as the Internet, or any other means of connection. Using the customer host 441, the customer 442 uses the Program Server 410 to (1) select programming information stored on or accessible from the Program Server 410 (e.g., create a Program List) and (2) transfer the programming information from the Program Server 410, over the WAN 417, to the remote host 415. The remote host 415 then (1) translates the programming information into a sequence of KEYS, (2) translates the sequence of KEYS into control packets containing control codes, and (3) transfers the control packets to the signal transmitter 420 to control the recorder 406. Alternatively, if the signal transmitter 420A contains processing circuitry, the remote host 415 transmits the programming information to the signal transmitter 420A, which translates the programming information into control packets and transmits the control packets to the recorder 406.

It will be appreciated that a clock or timer can be contained in the remote host 415, the signal transmitter 420A, or both. A timer or clock may be needed to keep the current time so that, for example, the Control Program knows when to transmit control signals to the recording device 406. If a timer or clock is contained in the remote host 415 but not the signal transmitter 420A, then the remote host 415 is preferably always ON. If a timer or clock is contained in the signal transmitter 420A but not the remote host 415, then the remote host 415 does not have to always be ON.

It will also be appreciated that the functions described above can be combined among the components in many ways. For example, a remote host could be configured to allow a customer to log onto it and access a Program Server. In this configuration, a remote host and customer host are the same machine. Similarly, a customer could log onto the Program Server and directly select programs from it. In this configuration, the customer host and the Program Server are the same machine. The present invention contemplates these and other combinations.

FIG. 6 shows a system 600, an alternative embodiment of the present invention. Identical elements in FIGS. 5-9 are labeled with the same numbers. In FIG. 6, the remote host 415 and a signal transmitter 420B are coupled by a USB card (not shown) contained in the signal transmitter 420B. The USB card contains a serial timer module, which can be used to keep the current time. Thus, the remote host 415 can be sometimes ON. When the remote host 415 is powered ON, it can synchronize its time with that of the serial timer module on the USB card. It will be appreciated that the remote host 415 can be coupled to the signal transmitter 420B using a serial card or other types on connectors.

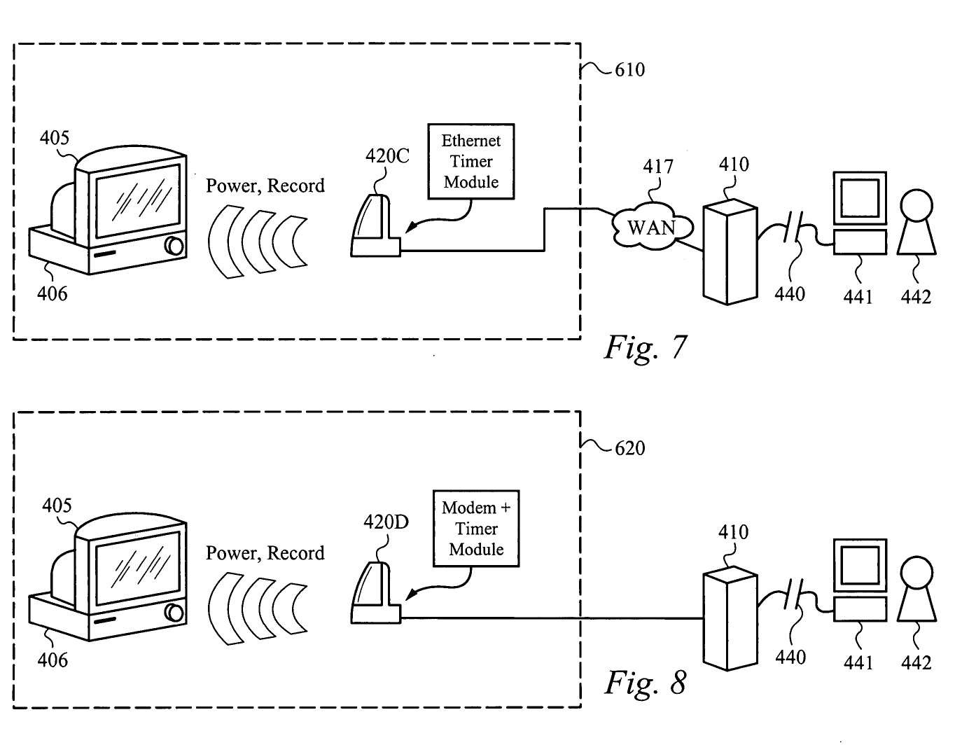

FIG. 7 shows a system 610 that implements a preferred embodiment of the present invention. The system 610 does not contain a remote host but instead contains a signal transmitter 420C coupled to the WAN 417, which in turn is coupled to the Program Server 410. The signal transmitter 420C contains a network card, such as an Ethernet card, that allows it to communicate with the Program Server 410 (e.g., receive programming information or control codes) over the WAN 417. The signal transmitter 420C, for example, receives the current time from a timer located on the network card. The timer is thus used to determine when to start and stop recording a program. An embedded controller (e.g., CPU, memory, Ethernet port, RS-232 port) in the signal transmitter 420C thus essentially gets RS-232 messages that have been tunneled across the WAN 417 from the Program Server 410.

In this preferred embodiment, the Program Server 441 translates programming information into corresponding control codes and transmits these control codes to the signal transmitter 420C at programmed times, such as every 10 minutes. Alternatively, the signal transmitter 420C fetches the control codes from the Program Server 441 at programmed times. The signal transmitter 420C then emits corresponding control signals to the recording device 406. Thus, for example, in processing the programming information “Thursday, 8:00 p.m., channel 3, 1 hour”, the Program Server would translate the programming information into two sets of control codes, the first set corresponding to the control codes “Channel 3, POWER ON, RECORD”, used to begin recording of the selected program at the record start time (Thursday, 8:00 p.m.), and a second set of corresponding to the control codes “STOP RECORDING, POWER OFF”, used to stop recording at the record stop time (Thursday, 9:00 p.m.). Preferably, when the signal transmitter 420C receives the control codes, it stores them in a table containing the channel, start time, and stop time for each program. At both the start and stop times, the signal transmitter 420C emits the appropriate control signals to the recording device 406. Thus, at the record start time (Thursday, at 8:00 p.m.), the signal transmitter 420C will emit control signals on which are encoded the first set of control codes to start recording the program on the broadcast channel. At the record stop time (Thursday, at 9:00 p.m.), the signal transmitter 420C will emit control signals on which are encoded the second set of control codes to stop recording.

FIG. 8 shows a system 620 in accordance with an embodiment of the present invention. FIG. 8 comprises a signal transmitter 420D coupled to a Program Server 410 by a telephone line and a modem (not shown) contained in the signal transmitter 420D. The modem contains a timer module for keeping track of the current time. The timer module is thus used to determine when to start and stop recording a program.

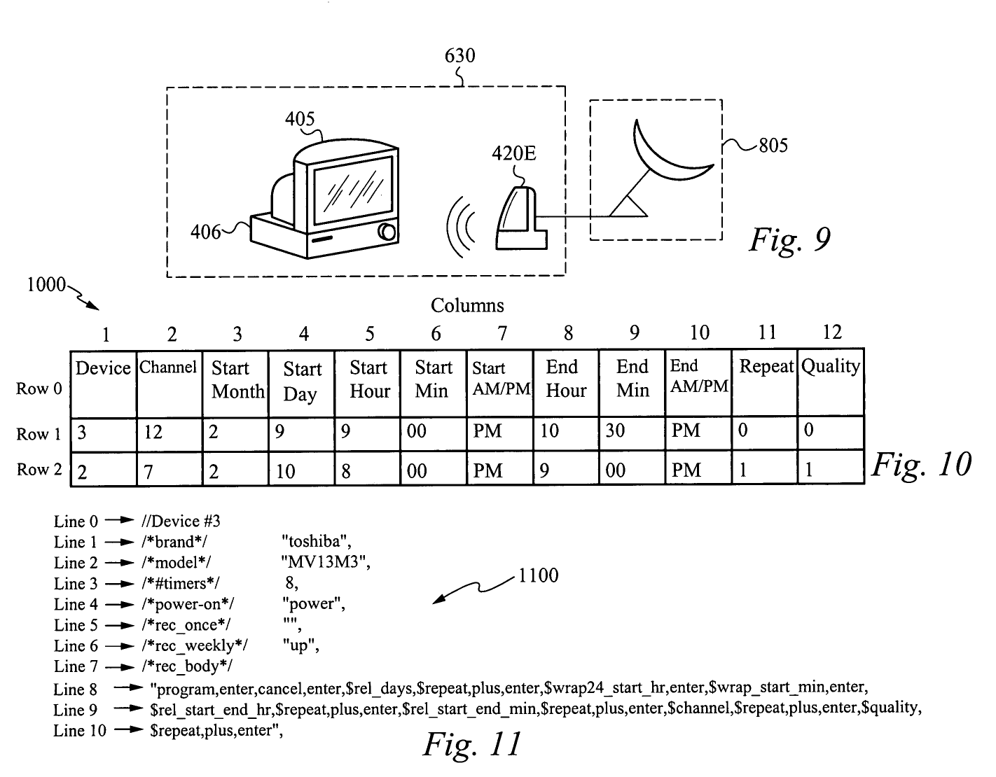

FIG. 9 shows a system 630 in accordance with an embodiment of the present invention. The system 630 comprises a source 805 coupled to a signal transmitter 420E. The source 805 comprises a satellite receiver or digital cable tuner 805 configured to receive either programming information, such as a Record List, or control codes from, for example, a Program Server (not shown) using satellite transmission. If the signal transmitter 420E is configured to receive a Record List, then it must contain a processor and memory used to translate the Record List into control codes and the control codes into control signals. Alternatively, the source 805 is used to perform the role of an embedded controller, translating the Record List into control codes. The signal transmitter 420E then translates the control codes into control signals.

It will be appreciated that the signal transmitters 420C, 420D, and 420E, in FIGS. 7, 8, and 9, respectively, each contains an embedded controller, including a processor, memory, serial or Ethernet ports, and a signal generator, such as an IR transmitter.

FIG. 10 shows the logical structure of a list of programming information 1000 (e.g., a Record List) for programs to be recorded. Preferably, the Record List is generated on a Program Server, where a user selects a list of programs to record. In a preferred embodiment, the Program Server translates the programming information into corresponding control codes and transmits the corresponding control codes to a signal transmitter. It will be appreciated, however, that the Program Server can transmit the programming information to other components, such as a remote host or a signal transmitter, either of which can be configured to translate the programming information into corresponding control codes. In one embodiment, the programming information is stored on the remote host so that a user at the remote host can view and edit the programming information.

The headings shown in Row 0 are used merely to describe the information in Row 1 and Row 2, and would not be part of the Record List 1000. Row 1 shows the programming information for a first program to be recorded. Referring to the columns labeled in Row 0 and the corresponding columns in Row 1, the first program in the Record List 1000 is to be recorded on Device 3 (column 1), e.g., a Toshiba video cassette recorder, on Channel 12 (column 2), on Month 2 (column 3), i.e., February, starting on the 9^{th} day (column 4), at 9:00 pm (columns 5-7), ending at 10:30 p.m. (columns 8-10). The recording will not be repeated (column 11) and will be recorded using a low quality recording (column 12), such as a low tape speed for a video cassette recorder or a low compression algorithm for a digital video recording, thus allowing for more programs to be recorded on a video cassette recorder or other recorder identified by “Device 3.”

Similarly, referring to Rows 0 and 2, the second program in Record List 1000 is to be recorded on Device 2 (column 1), e.g., a Panasonic digital video recorder, on Channel 7 (column 2), on Month 2 (column 3), i.e., February, starting on the 10^{th} day (column 4), at 8:00 pm (columns 5-7), ending at 9:00 p.m. (columns 8-10). The recording will be repeated (column 11) and will be recorded using a high quality recording (column 12). When referring to digital storage, the quality generally refers to the compression technique used. For example, high quality storage uses compression techniques such as MPEG-2 that allow for truer reproduction of the original data but uses more memory. Lower quality storage uses compression techniques such as MPEG-1 that allow for less true reproduction but uses less memory.

It will be appreciated that while FIG. 10 logically shows the programming information stored in records (e.g., rows), programming information can be stored in other data structures in accordance with the present invention. As discussed below, a Control Program executing on the remote host reads the records in a Record List and translate them into a series of control codes in accordance with the present invention.

As described above, sequences of control codes are generated in a variety of ways according to the present invention. For example, a template can be used to generate KEY sequences for recording a program on a particular recording device. Thus, when the Control Program determines that a program is to be recorded, it fills out a device template containing the sequence of KEYS for recording a program, substitutes the variables for, for example, the channel and start time, and then replaces the KEYS with control codes. This latter step is similar to a preprocessor in a compiler expanding a macro. The generated sequence of control codes are then ready to be transmitted to a signal transmitter.

FIG. 11 shows an exemplary device template 1100 for Device 3 in accordance with the present invention. It will be appreciated that the device template 1100 is used when the recording device is to be programmed to record a program at a later date. Alternatively, programs are recorded using the POWER ON, CHANGE CHANNEL, RECORD, and POWER OFF control sequences as discussed above.

The device template 1100 is a human-readable macro having Line 0 through Line 10 and is used to set device parameters to generate control codes for remotely controlling Device 3. As is known to those skilled in the art, the device template 1100 includes strings that a computer program (e.g., an interpreter when using a scripting language or a preprocessor when using a compiled language) will replace with values defined elsewhere in a program, such as the Control Program.

The device template 1100 includes information used to inform a human reader which device the template corresponds to and the information needed to control the device. For example, Line 0 indicates that the device template 1100 is for Device 3. Thus, when parsing Row 0 of the Record List 1000 in FIG. 10, the Control Program knows that the template needed to program Device 3 is given by the device template 1100. It will be appreciated that other templates are used to control Device 3 in other ways, such as to set its timer. The device template 1100 includes a human readable brand name in Line 1 (“Toshiba”) and a human-readable model number in Line 2 (“MV13M3”). The device template 1100 also includes the number of timers in Line 3, which indicates the number of programs that can be recorded on Device 3 using the timer. This value can thus be used by the Control Program to ensure that the user has not tried to program Device 3 to record more programs than it is capable of recording. The Lines 4-6 indicate, respectively, the key sequences for POWER (Line 4), Record Once (Line 5), and Record Weekly (Line 6). These strings will be replaced with their control codes when the device template 1100 is expanded.

In one embodiment, the Device Template 1100 includes macro substitutions. For example, as shown in FIG. 11, the elements without a preceding dollar sign ($) are replaced by bit sequences that form a control code; elements having a preceding dollar sign are variables and are replaced by corresponding values in the Record List 1000 or by values generated using the corresponding values in the Record List 1000. Thus, for example, the first element of the rec_body string in Line 8 contains the element “program”. When the string is expanded using macro substitution, the element labeled “program” is replaced by the control code generated when the PROGRAM button on the remote for the Toshiba MV13M3 is pressed, e.g., the control code (bit sequence) 11001101.

Similarly, the variable $rel_days is computed using the Start Date found in Row 1, Column 4, of the Record List 1000. Thus, for example, if the Start Date equals 9 and the Current Date is 17, then $rel_days is −8, corresponding to the fewest number of keys that can be pressed to go from the Current Date to the Program Start Date. That is, assuming that the days that can be displayed using a remote control goes from 1 to 31, it takes 8 presses of the DOWN key button (hence, the negative value) to go from 17 to 9, versus 23 key presses of the UP key. Thus, in this example, the variable $rel_days will be replaced with the control sequences for the key DOWN code, and the $repeat will be replaced with the same code sequence 6 times.

In a similar manner, the remaining constants and variables are expanded, and the generated control sequences corresponding to the key sequences for programming a recorder to record a program as indicated in each row of the Record List 1000 is generated. Thus, Lines 8-10 will be expanded to contain the control codes for the keys PROGRAM, ENTER, CANCEL. Next, the control codes for the relative number of days, repeated ($rel_days, $plus), is generated as described above. Next, the control codes for the PLUS and ENTER keys are generated. Next, the control codes for the KEY sequences corresponding to the variable $wrap24_start_hr are generated. The $wrap24_start_hr variable contains a variable corresponding to the shortest number of keys that must be pressed to go from the current hour to the hour of the program to be recorded. Thus, for example, if the current hour is 12 and the Start Hour, shown for example in Column 5, Row 1 in FIG. 10, is 9, it will take 3 presses of the DOWN key to reach the number 9. Thus $wrap24_start_hr will be computed to equal 3 DOWN key (thus encoded as a variable since it changes with time) and then will be replaced with three instances of the control code for the DOWN key.

Continuing with FIG. 11, the control code for the ENTER key is generated, followed by the control code for the variable $wrap_start_min. The variable $wrap_start_min will be replaced by a control code that varies, depending on the difference between (1) the minute of the day recognized by the video recorder and (2) the minute of the day that the video recorder should start recording. Again, the Control Program will compute the “shortest path” and replace the value with the corresponding control code. In a similar manner, the variable $rel_start_end_hr will be replaced by the shortest sequence of control codes for entering the starting hour and the ending hour. The variable $rel_start_end_min will be replaced by the control codes corresponding to the shortest path (fewest keystrokes) for entering the starting and ending minutes. Variables beginning with “$rel” thus refer to relative values. The variable $channel is replaced by the control code corresponding to the channel to be recorded. And the variable $quality corresponds to the recording quality, either a tape speed if the recorder is a video cassette recorder or a compression algorithm if the recorder is a digital video recorder.

It will be appreciated that the sequence of control codes is unique to each recording device. For example, one video recorder may require that the sequence of control codes needed to record a program is PROGRAM, ENTER, UP KEY, CHANNEL 5, 9, etc. A second video recorder may require that the sequence of control codes to program the identical program is PROGRAM, 9, ENTER, CHANNEL 5, ENTER, etc. Thus, the device template 1100 is for illustration only and can have any sequence of control keys depending on the particular device.

It will be appreciated that the strings in the device template 1100 can be altered using mathematical and other operators. In one embodiment, mathematical operators are identified by a leading dollar sign ($) such as the addition operator ($+), the subtraction operator ($−), the multiplication operator ($*), and the division operator ($/). The length of a device template (and thus the chance of typing error) can thus be reduced using mathematical operators. Thus, for example, instead of typing UP 30 times in the device template, the device template is instead written with the shortcut UP$*30. This mathematical equation will be expanded to the sequence of control codes corresponding to pressing the UP key thirty times in succession.

It will be appreciated that sequences of control codes for performing a particular task can be stored and generated in many ways in accordance with the present invention. For example, device information can be stored in an array or a hash (i.e., associative array). For example, the device name and the function (e.g., RECORD) could be used as the two keys of a hash; the control code sequence could be used as the value. For example, a value could be the sequence of control codes for setting the timer on a recording device.

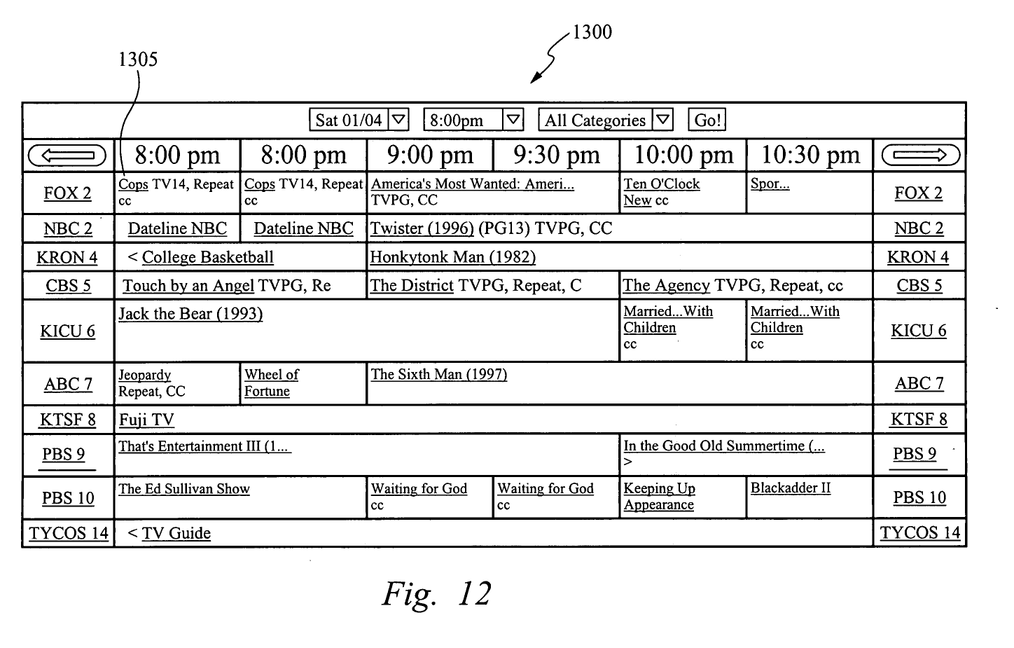

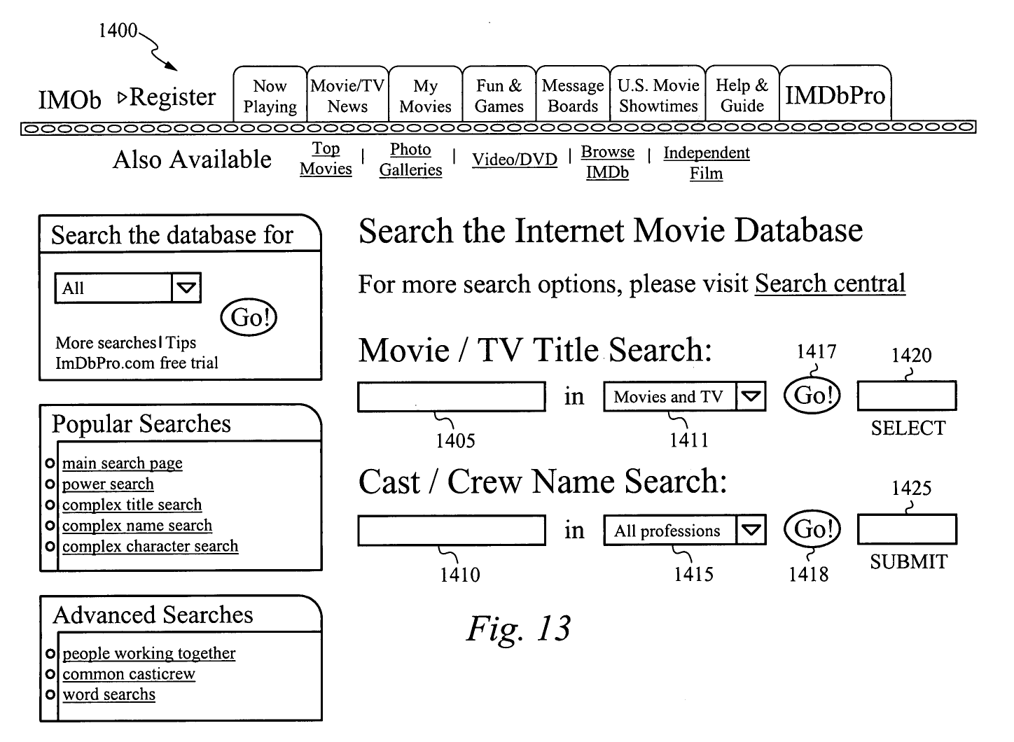

As described above, Program Servers can be used to generate Record Lists, containing programming information for programs to be recorded. FIGS. 12 and 13 show screen shots of GUIs displayed, for example, on a Program Server and used to select programs for recording (and thus storing in a Record List), in accordance with the present invention. For example, FIG. 12 shows a screen display of a Listing of TV Programs 1300 generated on a Program Server. The programs can be stored, for example, in a database of movies stored on the Program Server or accessible to the Program Server. In operation, a user logs onto the Program Server, observes the Listing of TV Programs 1300, and selects one or more for recording. For example, the user positions her mouse over the box 1305 for the program airing on the channel FOX2 from 8:00 p.m. to 8:30 p.m. and labeled “Cops TV14, Repeat CC.” By clicking on the mouse, the user indicates that she would like to record the program. After the Program Server recognizes and processes the mouse click, by for example using an event listener that monitors and processes mouse clicks, it formats a record containing programming information relating to the program. For example, the Program Server can create a record similar to that shown in Row 1 of FIG. 10: “3 2 10 9 8 00 PM 8 30 PM 0 0”. Including the columns within parentheses, the record indicates that the program is to be recorded on (1) Device number 3 on (2) Channel 2 on (3) October (4) 9^{th} (5-7) starting at 8:00 p.m. and (8-10) ending at 8:30 p.m. with (11) no repeats and (12) with low quality taping. Preferably, the Program Server converts this record into control codes, which it transmits to a remote host or directly to a signal transmitter. Alternatively, the Program Server transmits this record to a remote host or other component, which converts it to control codes, as described above.

It will be appreciated that control codes or record given above can be transmitted to the remote host, signal transmitter, or other component in any number of ways. For example, the record can be encapsulated within a TCP/IP message and sent to the remote host on a predetermined port. A program running on the remote host (e.g., a Control Program) and listening on that predetermined port can read the message, extract the record, generate a sequence of control codes using, for example, a device template, and send the control codes to a signal transmitter as described above. It will be appreciated that other protocols such as local area network protocols (e.g., Ethernet, fiber distributed data interface or FDDI) can be used to transmit records from a Program Server to a remote host.

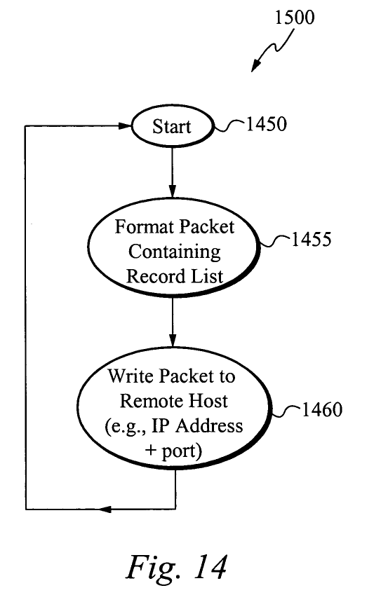

It will be appreciated that a Program Server can store and retrieve program listings in many other ways in accordance with the present invention. For example, FIG. 13 is a screen shot of an Internet Movie Database (IMDB) 1400. The IMDB 1400 allows a user to log onto it and enter search criteria into different fields. For example, entering a movie or TV title or a portion of the movie or TV title into the field 1405 and hitting the Go! Button 1417 will call a search engine that finds movies and television shows that have that title or portion of title. A listing of these movies and TV shows can then be displayed and then selected for later recording by clicking on the SELECT button 1420. Selected movies can, for example, be stored in a Record List that is later transmitted to a remote host. For example, entering the phrase “ET” into the field 1405 may bring up the movie “ET: The Extra Terrestrial” and the television show “ET: Entertainment Tonight.” The user can then select either or both of these programs to record by highlighting them and then clicking on the SELECT button 1420. When the user clicks on the SUBMIT button 1425, the Program Server will then format the appropriate records into Record List that is encapsulated into a transmission packet sent to a recorder, as described in FIG. 14 below, instructing the recorder to record the selected programs.

Similarly, the Program Server can be configured to accept wildcard characters to use when searching programs, such as the character “*” for any sequence of characters and “?” for a single character, similar to regular expressions used in computer programming. Thus, for example, entering the phrase “Sound of Music*” will bring up movies and TV programs with the titles “Sound of Music”, “Sound of Musicals”, “Sound of Music and other Plays,” but entering the phrase “Sound of Music???” will only bring up “Sound of Musicals.” The user could also select other databases selected from the pull-down menu 1411 in which to search.

Similarly, the user can enter the names of actors in the field 1410 and hit the Go! Button 1418 to generate a list of programs starring the actor. The user can use the pull-down menu 1415 to search for films, for example, in which a particular person was a producer or director. Those skilled in the art will recognize that the GUI shown in FIG. 13 can be used to find movie, TV programs, or other broadcast programs that meet more complex search criteria.

Search engines in accordance with the present invention search using many search methods, including stemming and canonicalization. For example, using stemming, search terms are broken down into their root terms and a search performed to find variations of the root. Using canonicalization, for example, search terms are translated into standard formats, such as translating TV titles into corresponding numerical TV program listing codes. In addition, the search engine is programmed to search for synonyms. Thus, when the word “plane” is entered in the Movie/Title field 1405 in FIG. 13, the search engine searches for movies or television programs with the words “airplane”, “aircraft”, or “plane” in its title.

The results of searches are used in many ways. For example, if the Program Server is configured to perform searches without user intervention, it alerts a user with a list of movie or TV program titles that match a search, including a list of the date, time, and channel on which the programs will appear. The Program Server alerts the user by e-mail, a printed screen display, or by any other appropriate means. Updated Record Lists can be e-mailed to the user whenever a change occurs (e.g., a requested program is rescheduled) or when a recording device's memory is full. Additionally, rather than alert the user about promising programs, the Program Server can be configured to automatically send the Record List or corresponding control codes to the remote host or directly to a signal transmitter to record the programs. It will be appreciated that a Program Server can be configured to search and process search results in a variety of ways.

In one embodiment, a user sets up a user account on the Program Server. When configuring her account, she can set, for example, (1) the host address (e.g., IP address or Ethernet address) of the remote host, where Record Lists and other programming information is sent, (2) an e-mail address to which alerts, described below, will be delivered, (3) a flag indicating whether any search results are automatically recorded or merely e-mailed to the user, and (4) a flag indicating whether she would like the Program Server to create a user profile. The user profile can keep track of the programs that the user has selected to be recorded in the past; the Program Server can then alert the user when similar programs (e.g., starring the same actor or having a similar term in their titles) are broadcast. The Program Server can also be configured to use collaborative filtering or other clustering techniques to characterize a user's viewing preferences and then alert the user to the broadcast of similar programs. The user can also configure her account so that her remote host periodically queries or “calls out” to the Program Server at predetermined times to request updated Record Lists or other programming information. Billing information can also be set using the user account.

The Program Server can also be configured to record a TV series starting from an initial episode. For example, a user may wish to record reruns of a television program but only after it cycles around to its first season. Within a GUI (not shown) on the Program Server, the user can enter the name of the TV series in a first field and then selects the term “First season” from a pull-down menu. The Program Server can be configured to hold a TV database storing the starting year for each series. The Program Server can then search a database of current TV programs and create a Record List of TV Programs matching the title of the TV series and having the release date of the first year. Alternatively, the Program Server can search for the next airing of the TV series and check its production date. If the production date is more than one year earlier than the current episode, then it can be assumed that the series has cycled around. The aired program can then be added to the Record List. Alternatively, the Program Server can search for titles that contain the TV series title and also the word “pilot.”

Embodiments of the present invention can also extend the functionality of some recording devices. For example, some VCRs have a weekday (M-F) repeat value, and others have a daily value (Sun-Sat) repeat timer setting. The Control Program, for example, can be configured to convert between them as appropriate, by for example, replacing weekday program (e.g., a soap opera) with a daily timer setting. For daily programming, (such as the evening news) a weekday setting plus separate Saturday and Sunday repeating timer entries (i. e., 3 in total) can be used to record the program. Thus, fewer VCR timer entries are required.

Using the user profile, the Program Server can also keep track of the programs that the user has already recorded. The Program Server can thus alert a user when a program in a series that she has missed is being aired, or it can automatically generate a Record List and transmit it to the remote host for recording the program. The Program Server can also thus ensure that the same program is not automatically recorded more than once. Thus, if a TV program is broadcast four times a month, the Program Server can be set to ensure that it is automatically recorded only once.

Since viewing history is kept on the Program Server, it has the ability to keep track of every episode that a user has recorded. Embodiments of the present invention can thus use an “unrecorded” mode when selecting a series on a Program Server. Using this unrecorded mode, the Program Server will control the recording device to record an episode the user has not seen before. The system therefore selectively records only those series programs that a user has not viewed before. Embodiments of the present invention also have a “recorded” mode when selecting a series on a Program Server. Using this recorded mode, the Program Server will ensure that the same program is not recorded more than once and thus will conserve program storage space. In this mode, the Program Server first checks the list of programs that the user has recorded. If the requested program has already been recorded, the Program Server does not send control codes for recording the program to the remote host.

It will be appreciated that in accordance with the present invention, browsers can be configured to search many types of Program Servers. For example, the Program Server, remote host, or other host can include a text selection program such as a JAVA™ applet that can select titles, dates, and times from highlighted text on any Web site. The text selection program can generate a Record List from the highlighted text.

FIG. 14 shows the steps followed by a Program Server in accordance with the present invention. The process starts in the START step 1450. The START step 1450 is entered after a user has clicked on the SUBMIT button (1425, FIG. 13). Next, in the step 1455, the Program Server formats the Record List for transmission to the remote host. This is done by storing the Record List into a data structure in computer memory. Next, in the step 1460, the Record List is transmitted to the remote host. For example, the Control Program can call a WRITE command on the data structure, using the internet protocol (IP) address and port number for the remote host as the destination address. In a preferred embodiment, the Program Server translates the record List into a series of corresponding control codes that are transmitted to the remote host or signal transmitter.

It will be appreciated that while FIG. 14 shows a Record List being transmitted to the remote host, other control information can be transmitted to the remote host, such as commands to change the clock, reset the timer, program the remote host, or perform other tasks on a recording device.

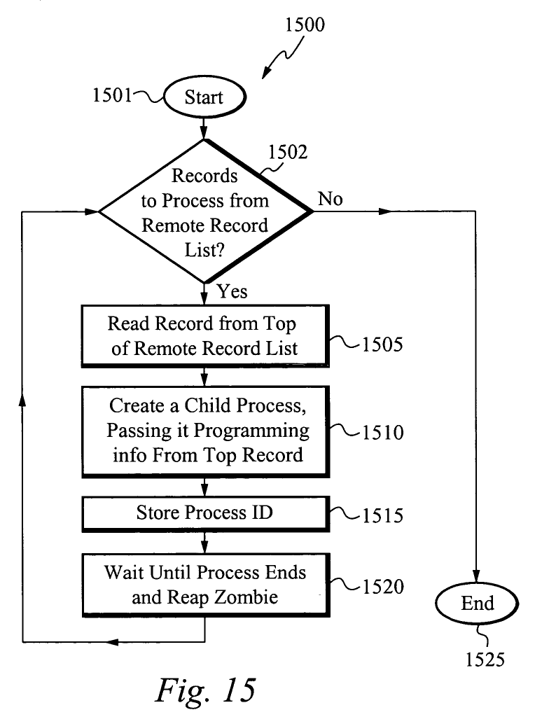

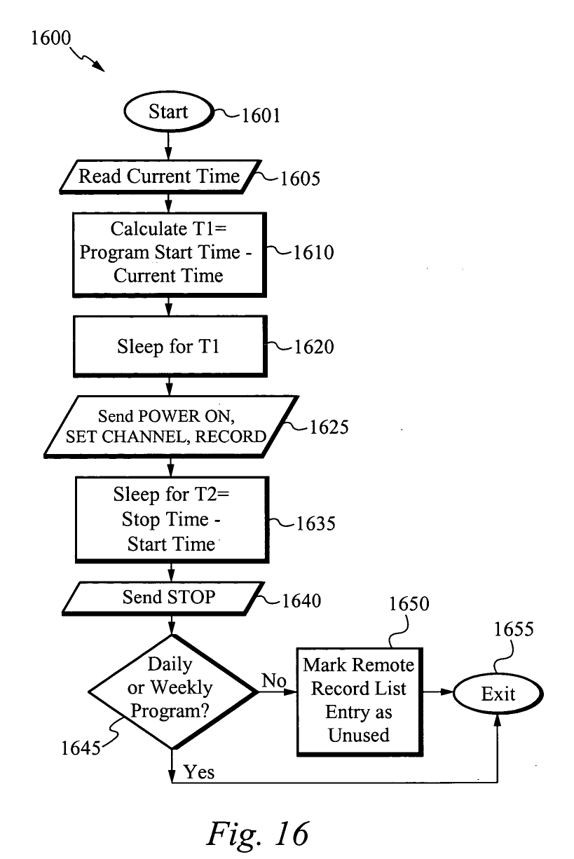

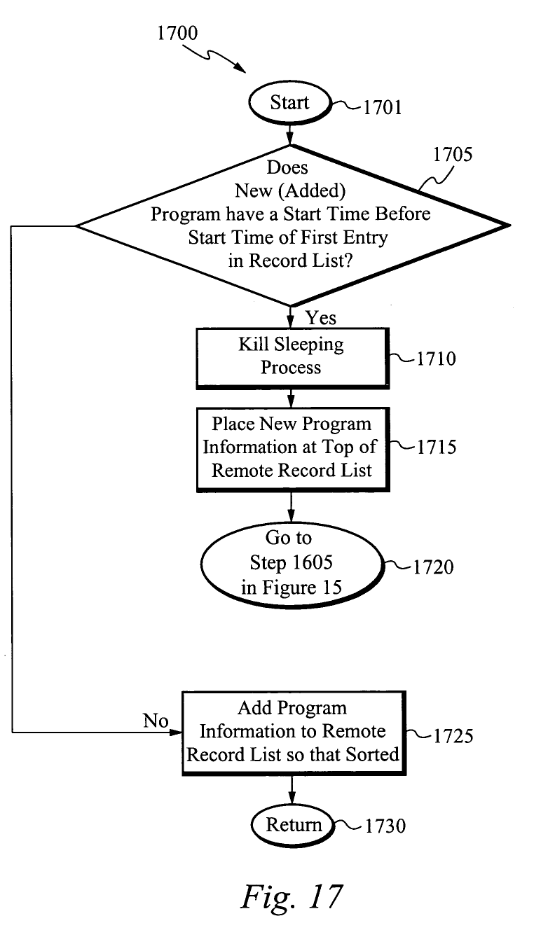

The Record List can be used to program the recording device to record one or more programs at a later date. FIGS. 15-19 are flow charts for steps used to “manually” record a program in accordance with the present invention, without programming the recording device. FIG. 15 is a flow chart 1500 depicting the steps executed by a Control Program to record programs in accordance with one embodiment of the present invention. First, in the step 1501, any uninitialized data or code used by the Control Program is initialized. The step 1501 can be entered when, for example, a transmission packet is received from a Program Server. The Control Program may listen on a particular socket and enters the step 1501 when a transmission packet appears on the socket. In the step 1501, the Control Program also stores the Record List in a data structure on the remote host, the Remote Record List. The records in the Record List will be added to any already stored in the Remote Record List, as described below.

Next, in the step 1502, the Control Program checks whether the Remote Record List contains any records indicating, for example, that a program is to be recorded. If there are no records for processing, the Control Program proceeds to the step 1525, ending the Control Program. If there are records to process, the Control Program continues to the step 1505 and reads the topmost record in the Remote Record List. Next, in the step 1510, the Control Program creates a child process (e.g., a process, lightweight process, thread, etc.), passing it programming information contained in the topmost record. Next, in the step 1515, the Control Program stores the process ID (PID, stored for example in a global variable nextPID) for the process, used later for killing the process when it has completed its tasks, described below, and for killing zombies. Next, in the step 1520, the Recording Program will wait until the process ends (i.e., a program was recorded) and reap any zombies, and will then loop back to the step 1502.

It will be appreciated that FIG. 15, like all the figures described herein, is illustrative of only one embodiment of the present invention. Other embodiments are contemplated. For example, in other embodiments, processes are not created and therefore zombie processes do not have to be reaped. Alternatively, an underlying operating system upon which the Control Program operates can be configured to automatically reap zombie processes or otherwise control processing in accordance with the present invention.

It will be appreciated that the Control Program can be called in a number of ways. For example, the Control Program listens on a port on the remote host, and is executed when a message from, for example, a Program Server is received. Alternatively, the Control Program can be executed from a command line or from a GUI on the remote host, after a user has updated a Record List. A user or program executes the Control Program at any time for various reasons.

FIG. 16 is a flow chart for the steps 1600 executed by a child process created (spawned) in the step 1510 of FIG. 15, in accordance with one embodiment of the present invention. First, at the start step 1601, data in the child process is initialized. Next, in the step 1605, the child process reads the current time and in the step 1610 it computes the time difference T1=Program Start Time−Current Time. The program time is read, for example, from a remote host (e.g., FIG. 5), a USB/serial timer (e.g., FIG. 6), an Ethernet card (e.g., FIG. 7), or a modem (e.g., FIG. 8). Next, in the step 1620, the child process sleeps for the duration T1.

Next, in the step 1625, at the start time (e.g., when a program is to be recorded), the child process wakes and transmits (e.g., using a signal transmitter) the control signals for the KEY commands POWER ON, SET CHANNEL, RECORD. It will be appreciated that other information such as Device Number, record quality, etc., is also transmitted. Next, in the step 1635, the child process computes the time difference T2=Program Stop Time−Current Time (the length of the program to record) and sleeps for the duration T2. Next, in the step 1640, when the child process wakes (e.g., when the program being recorded has ended), the child process transmits the STOP control signal to the recording device. Next, in the step 1645, the child process checks whether the program is to be recorded daily or weekly (checking, for example, the REPEAT field as shown, for example, in column 11 of FIG. 10), or whether it is to be recorded only once. If the program is to be recorded only once, the child process continues to the step 1650, where it marks the corresponding entry in the Remote Record List as unused, and then continues to the step 1655, where it exits. If the program is to be recorded more than once, then the child process continues to the step 1655. Thus, the entry remains in the Remote Record List and the corresponding program will again be recorded when it is next aired. It will be appreciated that a different program may be recorded if it is awarded the same time slot.

In accordance with one embodiment of the present invention explained in FIGS. 15 and 16, a Remote Record List is sorted by time, with the next occurring program to record at the top of the Remote Record List. This ensures that programs are recorded when they are broadcast. A Remote Record List is sorted in many ways (e.g., using a bubble sort or an insertion sort), using many data structures, such as circular queues or linked lists. FIG. 17 is a flow chart for adding entries (e.g., new programs to record) to a Remote Record List. Preferably, sorting is performed by a Control Program. First, in the start step 1701, any data structures are initialized. Next, in the step 1705, the Control Program checks whether the new program (corresponding to the added record) has a start time before the program currently stored in the topmost element in the Remote Record List. If the new program does not start at an earlier time, the Control Program continues to the step 1725, where the record corresponding to the new program (e.g., programming information) is added to the Remote Record List so that the Remote Record List remains sorted. Next, the Control Program continues to the step 1730, where it returns.

If the new program has a start time more recent than the current topmost element in the Remote Record List, it must become the new topmost element; thus, the Control Program continues to the step 1710, in which it kills the sleeping process, to replace it with a process used to record the new program. Next, in the step 1715, the Control Program places the record (programming information) for the new program at the top of the Remote Record List. Next, in the step 1720, the Control Program continues to the step 1605 in FIG. 16. The new record will thus be processed to record the new program.

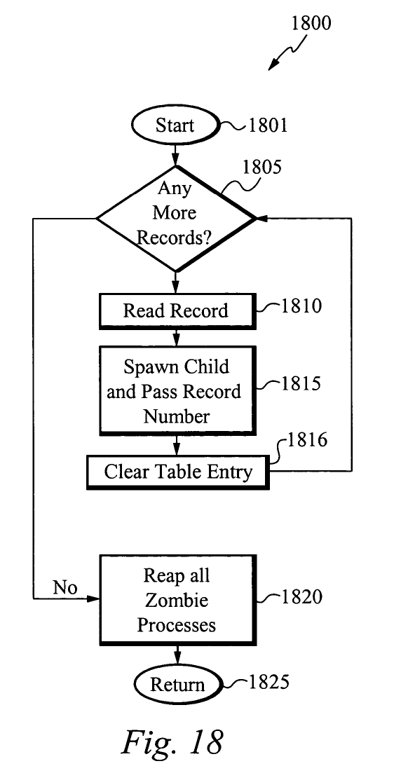

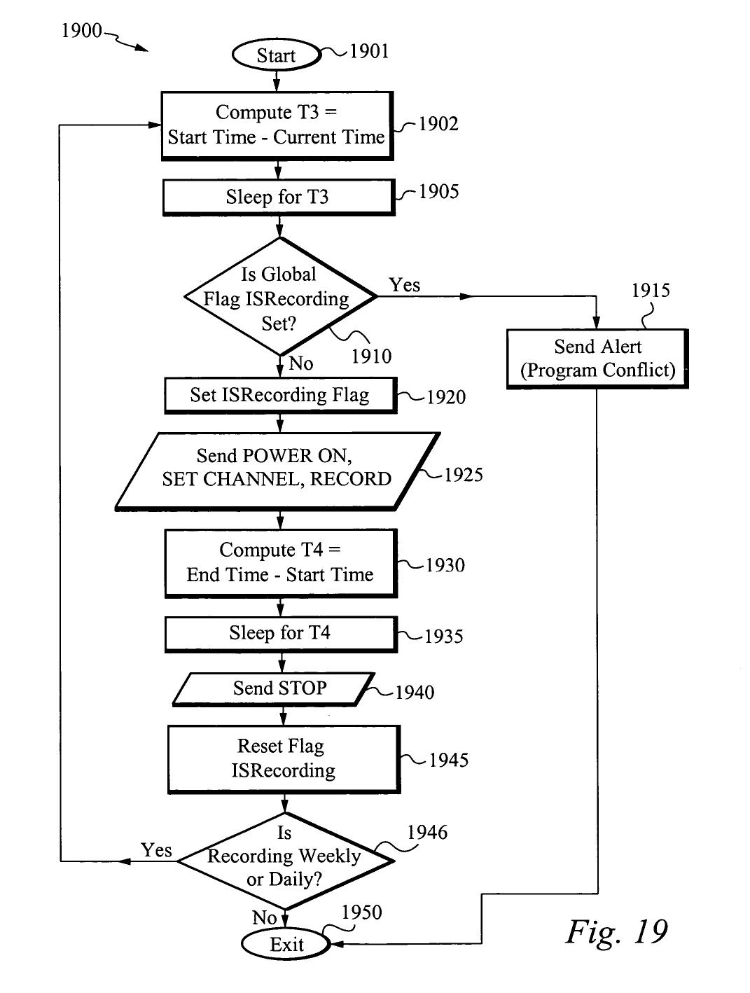

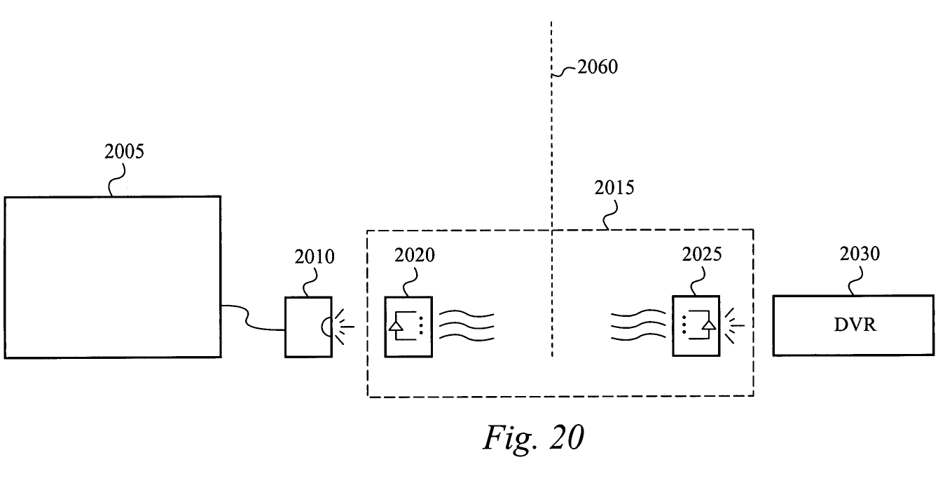

It will be appreciated that Control Program described in reference to FIGS. 15-17 supports only one child process at a time. Other configurations are contemplated by the present invention. For example, the Control Program can create multiple child processes corresponding to multiple programs to be recorded. In this way, a Remote Record List does not have to be sorted and child processes killed to take into account new programs to be recorded. FIG. 18 illustrates steps 1800 taken by the Control Program, the parent process, in accordance with embodiments of the present invention, and FIG. 19 illustrates the steps 1900 taken by a child process.

As shown in FIG. 18, in the step 1801, the Control Program performs any initialization. Next, in the step 1805, the Control Program parses the Remote Record List to determine whether any more records containing programming information must be processed. If there are no more records to process, the Control Program continues to the step 1820, where it reaps any zombies, and then continues to the step 1825, where it returns. If there are more records to process, the Control Program proceeds to the step 1810, where it reads the record. Next, in the step 1815, the Control Program spawns a child process, passing it the relevant programming information. Next, in the step 1816, the Control Program clears the entry in the Remote Record List corresponding to the child process. The Control Program then continues to the step 1805.

FIG. 19 is a flow chart for a child process spawned in the step 1815 of FIG. 18. First, in the step 1901, the child process performs any initialization steps. Next, in the step 1902, the child process reads the current time from, for example, a system clock, reads the Program Start Time from the record, and computes the time difference T3=Program Start Time−Current Time. Next, in the step 1905, the child process sleeps for the time T3. In the step 1910, the child process wakes (e.g., at the start of the program to be recorded) and checks a global flag (accessible to all of the child processes) ISRecording, that indicates whether the recording unit (indicated in the Device Number field of the child process) is now recording. If the ISRecording flag is set, the Control Program continues to the step 1915, where it sends an alert that there has been a programming conflict. The alert may be an e-mail to the user, including information about the program that was not recorded (e.g., the title, time, etc.). The alert can also include generating a message on a user display, logging the message to a file, etc. The child process then continues to the step 1950, where it exits.

If the ISRecording flag is not set (e.g., no other program is being recorded on the particular recording device), the child process continues to the step 1920, where it sets the ISRecording flag. Next, in the step 1925, the child process transmits to the recording device control signals for the keys POWER ON, SET CHANNEL, RECORD. Next, in the step 1930, the child process computes the time difference T4=Program End Time−Program Start Time (e.g., the program length), and in the step 1935, it sleeps for the duration T4. Next, in the step 1940, when the child process wakes (e.g., when the program has ended), the child process transmits the control signals for the key STOP to the recording device. Next, in the step 1945, the child process resets the ISRecording flag and continues to the step 1946. In the step 1946, the child process checks whether the program is to be recorded daily or weekly. If the program is to be recorded daily or weekly, the child process loops back to the step 1902. Otherwise, the child process continues to the step 1950, where it exits.

It will be appreciated that the flow charts 1800 in FIG. 18 and 1900 in FIG. 19 have been simplified for the description of the present invention. For example, the Control Program will check that the start date and time of the program requested to be recorded has not already passed. Other error checking will also be performed by both the Control Program (parent process) and the child processes. The Control Program can also be configured to alert the user that a program was successfully recorded.

It will also be appreciated that programs can be manually recorded in accordance with the present invention in many other ways. For example, rather than using parent and child processes, a Control Program or other program can use timers to determine when a program is to be recorded, and interrupt service routines that generate the control codes and control signals to record the programs. For example, in the PERL programming language, the “alarm” function is used to send a process a signal at the start time of a program and at the ending time of the program.

It will also be appreciated that multiple programs can be recorded using a combination of manual recording (using, e.g., a RECORD control signal at the program start, such as described in reference to FIGS. 16-19) and programmable recording, by, for example, using the PROGRAM control code to program a recording device. For example, a VCR can be controlled using the PROGRAM control code until its capacity for doing so is reached. This can be determined by the number of timers the recording device has, indicated, for example, by the value in Line 3 of FIG. 11. After all of these timers have been assigned to record a program, additional programs can still be recorded manually using, for example, the steps outlined in FIG. 19. It will be appreciated that recording methods can be combined in any number of ways in accordance with the present invention.

It will be appreciated that the embodiments outlined in FIGS. 14-19 are illustrative only and can be modified in accordance with the present invention. For example, in another embodiment, the Program Server generates a Record List of programs selected for recording, translates the Record List into programming information, translates the programming information into a corresponding sequence of control codes used to record the programs, and formats a packet containing the sequence of control codes, and transmitting the packet to a signal transmitter. Preferably, the packet is transmitted to the signal transmitter over a wide area network such as the Internet and the control codes are used for manually recording the programs on a recording device. Alternatively, the control codes are used to program the recording device to record the programs at a pre-selected time. In one embodiment, the control codes are stored in a data structure serving a similar function as the Remote Record List described, for example, in FIG. 15. In this embodiment, the control codes are stored in an array and are transmitted to a signal transmitter at or near the start time of a program (e.g., POWER ON, RECORD) and at or near a stop time of the program (e.g., STOP, POWER OFF).

In accordance with other embodiments of the present invention components can also be used to extend the reach of the signal transmitter. For example, IR extenders can be used to couple signal transmitters to a recording device. For example, as shown in FIG. 20, an IR extender 2015 can be used to couple a Signal Transmitter 2010 of a remote host 2005 to a digital video recorder (DVR) 2030. As is known to those skilled in the art, a first segment 2020 of the IR extender 2015 receives IR signals from the signal transmitter 2010, translates them into radio frequency (RF) signals, which are transmitted to the second segment of the 2025 of the IR extender 2015. The second segment 2025 translates the RF signals back to IR signals, which are then transmitted to the DVR 2030. FIG. 20 illustrates the RF signal traveling from the first segment 2020, though a wall 2060, and to the second segment 2025. Because RF signals can travel through walls and over longer distances than IR signals, the Signal Transmitter 2010 can transmit control signals to the DVR 2030 over larger distances than could the IR signals.

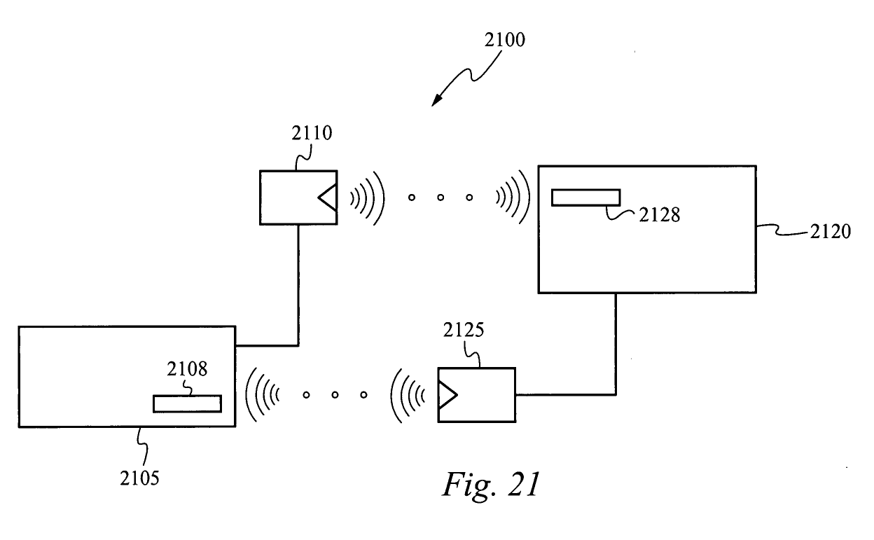

Embodiments of the present invention are used in accordance with other systems that allow recording components and control components to be placed remotely. FIG. 21 illustrates one recording system 2100 that allows a viewing device that is controlled in accordance with the present invention, such as a TV or PC, to be placed at a location remote from a video source, such as a satellite or cable box. The recording system 2100 comprises a video source 2105, which has a signal receiver 2108 and is coupled to a video sender 2110, described in more detail below. The recording system 2100 further comprises a personal computer 2120 having a display terminal. The personal computer 2120 also has a signal receiver 2128 and is coupled to a signal transmitter 2125. In one embodiment, the personal computer 2120 is coupled to a Program Server (not shown) and is configured to receive control codes for recording programs such as described above. Preferably, the personal computer 2120 is coupled to the Program Server by a wide area network such as the Internet. It will be appreciated, however, that the personal computer 2120 can be coupled to the Program Server using other means, such as by a local area network. It will also be appreciated that control codes can be transferred from other devices, such as a PDA, onto the personal computer 2120.

In operation, the personal computer transmits control signal to the signal transmitter 2125. The signal transmitter 2125 transmits a sequence of control signals to the signal receiver 2108. The control signals can, for example, change the channel of the program transmitted from the video source 2105, to the video sender 2110, and to the signal receiver 2128. The personal computer 2120 is programmed or otherwise controlled to record the one or more programs that it receives from the video sender 2110, storing the recorded one or more programs on a hard drive of the personal computer 2120. It will be appreciated that the video sender 2110 can transmit a video or other signal using RF signals, fiber optic cables, or any other means that fit the application at hand.

The current invention is also used to record audio programs in many ways. One embodiment of the present invention comprises a Wifi node, an AM/FM tuner, and an MP3 recorder/player, all of which are housed in a car. A user selects radio programs using a Program Server, which sends the timer entries to the module (i.e., the Wifi node, AM/FM tuner, and MP3 recorder/player) whenever the car is within Wifi range (e.g., in the garage at night). The module then records programs off the air at their start times.

In accordance with the present invention, a user remotely controls the programming of video and audio programs. The user easily selects programs to record by searching for movie, TV, audio, and other programs using search databases, accessible using GUI and other tools that simplify the search process. Others tools provide a user to be notified when movies and programs that may interest her are aired. Using the remote control capabilities provided by the present invention, a user does not have to memorize difficult programming sequences needed when programming a VCR to record a program at a later date; nor must she keep multiple remote control units for multiple recording devices.

It will be readily apparent to one skilled in the art that various modifications may be made to the embodiments without departing from the spirit and scope of the invention as defined by the appended claims.

We claim:

1. A system comprising:
a. a programmable first unit configured to translate programming information into one or more remote control codes; and
b. a signal transmitter coupled to the first unit, the signal transmitter configured to translate the remote control codes into control signals for controlling a recording device and to transmit the control signals to the recording device.

2. The system of claim 1, wherein the first unit comprises a program server coupled to the signal transmitter.

3. The system of claim 2, wherein the program server is configured to generate the programming information and to translate the programming information into the remote control codes.

4. The system of claim 2, further comprising a remote host coupled to the program server and to the signal transmitter, wherein the program server is configured to generate the programming information and the remote host is configured to receive the programming information and to translate the programming information into the remote control codes.

5. The system of claim 4, wherein the program server is coupled to the remote host over a wide area network.

6. The system of claim 5, wherein the wide area network comprises the Internet.

7. The system of claim 4, wherein the program server is coupled to the remote host over a local area network.

8. The system of claim 1, wherein the programming information corresponds to an occurrence of a program.

9. The system of claim 8, wherein the program is a broadcast video program.

10. The system of claim 8, wherein the program is a broadcast audio program.

11. The system of claim 1, wherein the signal transmitter is programmed to automatically transmit the control signals to the recording device at programmed times.

12. The system of claim 1, wherein the remote control codes are configured to program the recording device to automatically record a program at a programmed time.

13. The system of claim 1, wherein the signal transmitter comprises a personal digital assistant.

14. The system of claim 1, wherein the signal transmitter comprises a cellular phone.

15. The system of claim 1, further comprising a recording device configured to receive the remote control signals.

16. The system of claim 15, wherein the recording device comprises a video cassette recorder.

17. The system of claim 15, wherein the recording device comprises a digital video recorder.

18. The system of claim 15, wherein the recording device comprises an audio recorder.

19. The system of claim 18, wherein the audio recorder comprises:
a. a wireless receiver;
b. an audio tuner coupled to the wireless receiver; and
C. a programmable digital recorder coupled to the audio tuner, the programmable digital recorder configured to receive remote control codes over the wireless receiver from a program server at programmed times.

20. The system of claim 2, wherein the program server is configured to select one or more programs from a pool of programs, thereby generating a list of programming information.

21. The system of claim 20, wherein the program server is configured to select the one or more programs using a selection criterion.

22. The system of claim 21, wherein the selection criterion is that a segment of a program title matches a target string.

23. The system of claim 21, wherein the selection criterion is that a season number of a program matches a predetermined season number.

24. The system of claim 1, wherein the signal transmitter is coupled to the recording device by an infra red transmitter.

25. The system of claim 1, wherein the signal transmitter is coupled to the recording device by a radio frequency transmitter.

26. The system of claim 1, wherein the signal transmitter is coupled to the recording device by a serial bus.

27. The system of claim 1, further comprising a radio frequency extender coupling the first unit to the recording device.

28. The system of claim 3, wherein the remote host and the signal transmitter are a single machine.

29. A system comprising:
a. means for programmably generating one or more remote control codes used to record a program on a recording device; and
b. means for translating the remote control codes into control signals for controlling the recording device, the means for transmitting further configured to transmit the control signals to the recording device.

30. A method of recording a program, the method comprising:
a. transmitting one or more remote control codes to a first device;
b. receiving the remote control codes on the first device;
c. translating the remote control codes into control signals to control a recording device to record a program; and
d. transmitting the control signals from the first device to the recording device.

31. The method of claim 30, further comprising translating programming information related to the occurrence of a program into a sequence of the remote control codes.

32. The method of claim 31, wherein the sequence of remote control codes corresponds to a key sequence for recording a program.

33. The method of claim 32, wherein the program is a broadcast video program.

34. The method of claim 32, wherein the program is a broadcast audio program.

35. The method of claim 32, wherein the remote control codes are transmitted to the first device at programmed times.

36. The method of claim 32, wherein the remote control codes relate to programming the recording device to record a program at a programmed time.

37. The method of claim 30, wherein the recording device comprises a video cassette recorder.

38. The method of claim 30, wherein the recording device comprises a digital video recorder.

39. The method of claim 30, wherein the recording device comprises an audio recorder.

40. The method of claim 30, further comprising presenting a pool of programs from which one or more programs can be selected for recording.

41. The method of claim 31, further comprising:
a. selecting one or more programs from the pool of programs; and
b. translating programming information related to the occurrences of the programs into the remote control codes.

42. The method of claim 41, wherein selecting a program is performed on second device coupled to the first device.

43. The method of claim 42, wherein the first device is coupled to the second device over a wide area network.

44. The method of claim 43, wherein the wide area network comprises the Internet.

45. The method of claim 43, wherein the first device and the second device are coupled over a local area network.

46. The method of claim 41, wherein selecting the programs and translating the programming information are performed on a single machine.

47. The method of claim 41, wherein the selected programs are selected according to a selection criterion.

48. The method of claim 47, wherein the selection criterion is that a segment of a program title matches a target string.

49. The method of claim 47, wherein the selection criterion is that a season number of a program matches a predetermined season number.

50. A method of recording a program, the method comprising:
a. wirelessly receiving programming information corresponding to the broadcast of the program;
b. tuning a receiver according to the programming information to receive the program; and
c. storing the program.

51. The method of claim 50, further comprising selecting one or more programs from a pool of programs, thereby generating a list of programming information, and wirelessly transmitting the list to the receiver.

52. The method of claim 51, wherein the one or more programs are selected from a pool of programs using a selection criterion.

53. The method of claim 52, wherein the selection criterion is that a segment of a program title matches a target string.

54. The method of claim 52, wherein the selection criterion is that a season number of a program matches a predetermined season number.

55. The method of claim 50, wherein the program is a broadcast video program.

56. The method of claim 50, wherein the program is a broadcast audio program.

57. A network of devices comprising:
a. a program server configured to select one or more programs from a pool of programs, thereby generating a list of programming information, the program server further configured to translate the list of programming information into remote control codes;
b. a signal transmitter configured to receive the remote control codes from the program server, the signal transmitter configured to translate the remote control codes into control signals and to transmit the control signals to a recording device; and
c. a recording device configured to receive the control signals for recording a program.

58. The network of devices of claim 57, wherein the programming information corresponds to the occurrence of a broadcast program.

59. The network of devices of claim 58, wherein the broadcast program is a broadcast video program.

60. The network of devices of claim 58, wherein the broadcast program is a broadcast audio program.

61. The network of devices of claim 57, wherein the signal transmitter is programmed to automatically transmit the remote control codes to the recording device at programmed times.

62. The network of devices of claim 57, wherein the remote control codes program the recording device to record the program at a programmed time.

63. The network of devices of claim 57, wherein the recording device comprises a video cassette recorder.

64. The network of devices of claim 57, wherein the recording device comprises a digital video recorder.

65. The network of devices of claim 57, wherein the recording device comprises an audio recorder.

66. The network of devices of claim 57, wherein the program server is coupled to the signal transmitter over a local area network.

67. The network of devices of claim 57, wherein the program server is coupled to the signal transmitter over a wide area network.

68. The network of devices of claim 67, wherein the wide area network comprises the Internet.

69. The network of devices of claim 57, wherein the program server is configured to select one or more programs from the pool of programs using a selection criteria.

70. The network of devices of claim 57, wherein the signal transmitter comprises an infra red transmitter electronically coupling the signal transmitter and the recording device.

71. The network of devices of claim 57, wherein the signal transmitter comprises a radio frequency transmitter electronically coupling the signal transmitter and the recording device.

72. The network of devices of claim 57, wherein the signal transmitter comprises a serial bus electronically coupling the signal transmitter and the recording device.

73. A system comprising:
a. a program signal source for receiving a program signal;
b. a first device coupled to the program signal source, the first device for transmitting the program signal;
c. a second device configured to receive and store the transmitted program signal; and
d. a signal transmitter configured to transmit remote control codes to the program signal source, thereby controlling the transmission of program signals from the first device to the second device.

74. The system of claim 73, wherein the program signal source is one of a cable box or a satellite box.

75. The system of claim 73, wherein the second device comprises a digital video recorder.

76. The system of claim 73, wherein the second device comprises a video cassette recorder.

77. The system of claim 73, wherein the first device is configured to transmit the program signal using radio frequency waves and the signal transmitter is configured to transmit the remote control codes using radio frequency waves.

78. The system of claim 73, further comprising a program server coupled to the second device, the program server configured to transmit the remote control codes to the second device, the remote control codes related to the recording of a program.

79. The system of claim 78, wherein the program is a broadcast video program.

80. The system of claim 78, wherein the program is a broadcast audio program.

81. The system of claim 78, wherein the program server is coupled to the second device over a wide area network.

82. The system of claim 81, wherein the wide area network comprises the Internet.

83. The system of claim 78, wherein the program server is coupled to the second device over a local area network.
